(19) United States
(12) Patent Application Publication
(10) Pub. No.: US 2019/0378435 A1
(43) Pub. Date: Dec. 12, 2019

(54) LENZ' LAW DEMONSTRATION DEVICE

(71) Applicant: Ken Scott, Norwood (CA)

(72) Inventor: Ken Scott, Norwood (CA)

(21) Appl. No.: 16/003,011

(22) Filed: Jun. 7, 2018

(51) Int. Cl. G09B 23/18; A63H 33/26; G09B 5/02

(52) U.S. Cl. CPC G09B 23/181; G09B 5/02; A63H 33/26

(57) ABSTRACT

A Lenz' Law demonstration device. The invention is a child's educational toy that demonstrates magnetics, Lenz' Law (which creates a current within the tube by creating a magnetic field that opposes the field of the falling magnetic—making the magnet fall more slowly as opposed to a nonmagnetic drop that would fall at the speed of gravity). A magnet is dropped into a larger diameter copper (or other ferromagnetic material) tube. The magnetic resistance then causes the magnet to drop at a slower speed in the tube therefore creating the appearance of anti-gravity and generating an electrical charge through the resistance.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of education and demonstration and more specifically relates to a Lenz' law demonstration device.

### 2. Description of Related Art

Scientific laws govern physics and explain much of the happening in the world we live in. Scientific laws and related experiments may have difficult concepts to explain to children and adults alike. One such concept is magnetism. It is helpful to have a visual demonstration to display a law such that it can be more readily understood and applied. A suitable solution is desired.

U.S. Pat/Pub. No. 4,267,647 to Clarence E. Anderson et al. relates to an apparatus for demonstrating magnetic force. The described invention includes an apparatus for demonstrating magnetic force comprising a plurality of disc-shaped rotors angularly displaced from each other on a common shaft and a number of magnets equispaced along the rims of the rotors. Stationary field magnets encircle the rotors in close proximity to the rotor magnets with like-poles of the rotor magnets and the field magnets facing each other. A high permeance magnetic shield is located in the air gap between each field magnet and the rotor to block opposing magnetic fluxes. Magnetic attraction between the rotor magnets and field magnets tend to rotate the rotor. In one embodiment, the shield at each field magnet is mounted on a pivot and is moved out of the air gap by arms attached to the rotor. The rotor magnets are first attracted to the magnetic shield, and, as a corresponding rotor and field magnet approach each other during rotation of the rotor, one of the arms causes the shield to pivot out of the gap to expose the rotor magnet to the field magnet. This creates a magnetic repulsion “kick” tending to further rotate the rotor. A weighted portion of the shield below the pivot, and an additional set of arms rotating with the rotor, automatically reposition the shield during rotation of the rotor. In another embodiment, stationary magnetic shielding located in the air gap is shaped to block only a portion of each field magnet from the gap. As the rotor is rotated toward the shielding by magnetic attraction, a “flywheel effect” causes the rotor magnet to swing past the shielding into view of the partially exposed field magnet to create the additional kick.

### BRIEF SUMMARY OF THE INVENTION

In view of the foregoing disadvantages inherent in the known education and demonstration art, the present disclosure provides a novel Lenz' law demonstration device. The general purpose of the present disclosure, which will be described subsequently in greater detail, is to provide a kid's educational toy that demonstrates magnetics, Lenz' law (which creates a current within the tube by creating a magnetic field that opposes the field of the falling magnetic—making the magnet fall more slowly as opposed to a nonmagnetic drop that would fall at the speed of gravity). A magnet is dropped into a larger diameter copper (or other ferromagnetic material) tube. The magnetic resistance then causes the magnet to drop at a slower speed in the tube therefore creating the appearance of anti-gravity and generating an electrical charge through the resistance.

A Lenz' law demonstration device is disclosed herein. The Lenz' law demonstration device includes a tube having an inner surface; an inner volume; and an outer surface; and a magnet; wherein the magnet travels within the inner volume; the inner surface providing a resistance as the magnet travels and thereby generates an electrical charge via the resistance. As such the Lenz' Law demonstration device is configured to demonstrate direction of current induced in a conductor by a changing magnetic field due to induction is such that it creates the magnetic field that opposes the change that produced it. The tube may have transparent ends or other means such that movement of the magnet can be readily viewed by onlookers. Certain embodiments may have connecting tubes and a kit is also disclosed herein for instructional use.

A method of using the Lenz' law demonstration device is also disclosed herein. The method of using Lenz' law demonstration device may comprise the steps of: 1) providing the Lenz' Law demonstration device, the demonstration device comprising: a tube having an inner surface; an inner volume; and an outer surface; connecting-tubes; and a magnet; 2) generating an electrical charge as the magnet travels (downward) within the inner volume; the inner surface providing a resistance; wherein use of the Lenz' Law demonstration device is used to demonstrate principals of magnetism; 3) converting potential energy to kinetic energy by use of the magnet passing through the tube with the resistance, as such the Lenz' Law demonstration device is configured to demonstrate direction of current induced in a conductor by a changing magnetic field due to induction is such that it creates the magnetic field that opposes the change that produced it. The method may further comprise the step of: using the connecting-tubes for conducting related experiments to demonstrate scientific laws.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a Lenz' law demonstration device, constructed and operative according to the teachings of the present disclosure.

FIG. 1 is a front perspective view of the Lenz' law demonstration device during an ‘in-use’ condition, according to an embodiment of the disclosure.

FIG. 2 is a front perspective view of the Lenz' law demonstration device of FIG. 1, according to an embodiment of the present disclosure.

FIG. 3 is a view of magnetism as demonstrated by the Lenz' law demonstration device of FIG. 1, according to an embodiment of the present disclosure.

FIG. 4 is a front perspective view of the Lenz' law demonstration device as versus a non-conducting tube shown for demonstration purposes, according to an embodiment of the present disclosure.

FIG. 5 is a flow diagram illustrating a method of use for the Lenz' law demonstration device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to education and demonstration and more particularly to a Lenz' law demonstration device as used to improve the means by which the concept of magnetism can be shown to young and old alike such that the concept can be readily understood.

Generally, a child's educational toy is disclosed herein that demonstrates magnetics, Lenz Law (which creates a current within the tube by creating a magnetic field that opposes the field of the falling magnetic, making the magnet fall more slowly as opposed to a nonmagnetic drop that would fall at the speed of gravity). The present invention demonstrates magnetic fields. The falling of the magnet within the copper tube's resistance can be used to generate an electrical charge. The device demonstrates Lenz's law using magnetic resistance. Different diameter and connecting tubes can be used to create different experiments in alternate embodiments. Further, by making the tube longer or changing the diameter the changes in speed can show the effects of the magnet and resistance. A magnet may for example be dropped into a larger diameter copper (or other ferromagnetic material) tube. The magnetic resistance then causes the magnet to drop at a slower speed in the tube therefore creating the appearance of anti-gravity and generating an electrical charge through the resistance. Kids are always fascinated with magnets, so the present invention provides a suitable display means such that they can understand the concept. This device provides a new way to demonstrate the power of magnetism in a new and entertaining way.

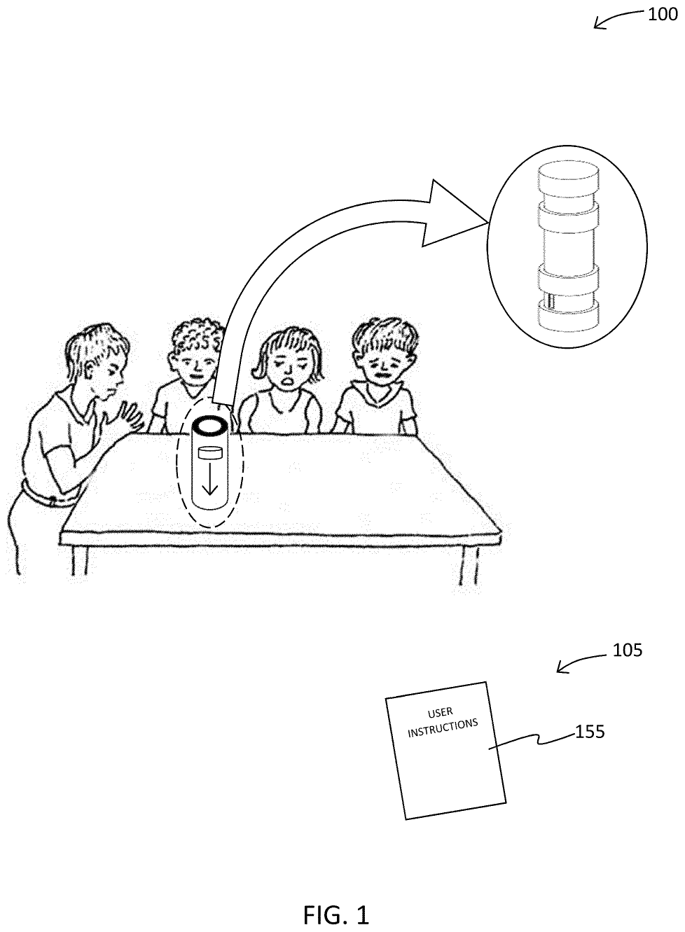

Referring now more specifically to the drawings by numerals of reference, there is shown in FIGS. 1-4, various views of a Lenz' law demonstration device 100. FIG. 1 shows a Lenz' law demonstration device 100 during an ‘in-use’ condition 150, according to an embodiment of the present disclosure. As Illustrated, the Lenz' law demonstration device 100 may include a tube 110 having an inner surface 112; an inner volume 114; and an outer surface 116; and a magnet 120; wherein the magnet 120 travels within the inner volume 114; the inner surface 112 providing a resistance as the magnet 120 travels and generates an electrical charge via the resistance. The tube 110 has a larger diameter than the magnet 120. As such the Lenz' Law demonstration device 100 is configured to demonstrate direction of current induced in a conductor by a changing magnetic field due to induction is such that it creates the magnetic field that opposes the change that produced it. In preferred embodiments the tube 110 comprises copper and in alternate embodiments may comprise other ferromagnetic material. Shown via indication arrows are the Eddy Current in a circular motion and the magnet motion of travel is indicated by downward motion as when dropped. In certain embodiments Lenz' Law demonstration device 100 may comprise tube 110 in the following exemplary manner: the top of plastic (clear), followed downwardly by a copper tube, then a clear plastic tube, copper tube, clear plastic, a copper tube with 2-4 (or more) side cutouts, and a clear plastic tube (all fit together in series). Other embodiments may be used. In this way viewers are able to see the experiment as it progresses such that learning can occur from observation. Tube 110 may come in different lengths and widths as well as different cutouts may be used in the copper tube portions.

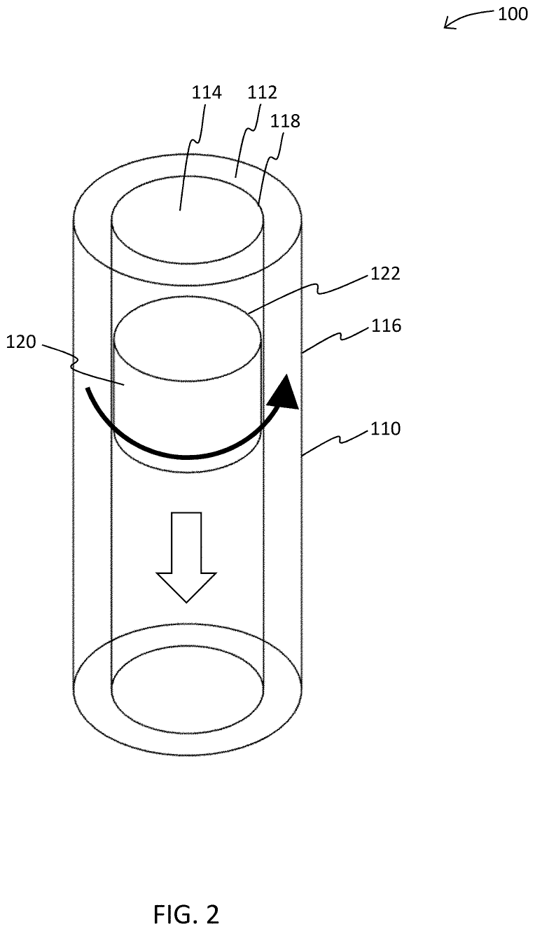

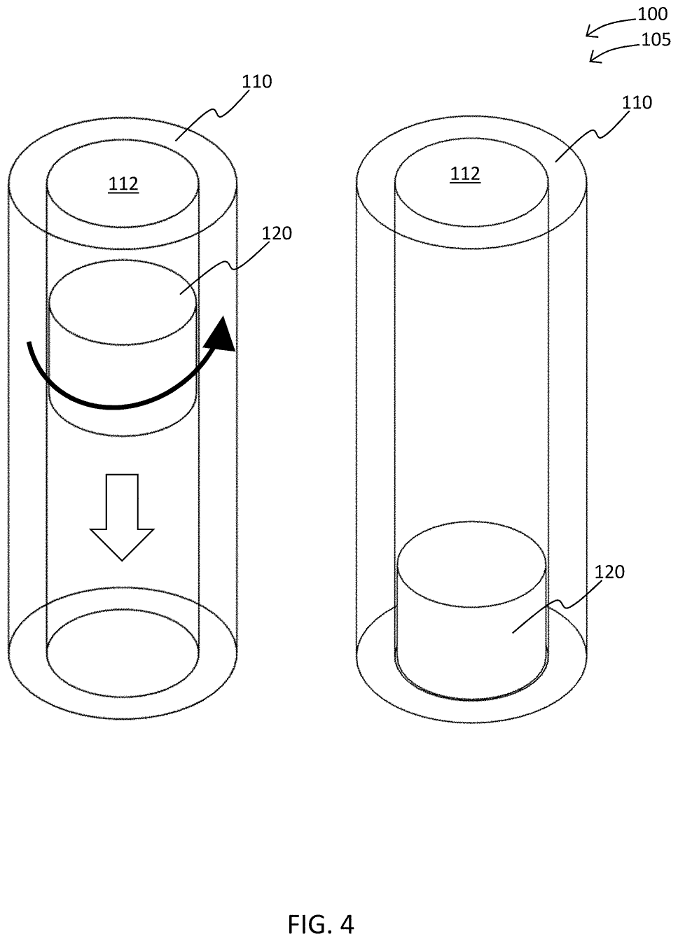

FIG. 2 is a front perspective view of the Lenz' law demonstration device 100 of FIG. 1, according to an embodiment of the present disclosure. The Lenz' Law demonstration device 100 visually demonstrates that the magnet 120 (due to the resistance) is caused to drop at a slower speed in the tube 110 therefore creating an appearance of ‘anti-gravity’ and generating the electrical charge through the resistance as also shown in FIG. 4. Changing a diameter of the tube 110 and changes in speed can show effects of the magnet 120 and the resistance. The copper tube 110 creates a magnetic drop due to the resistance whereas the right side tube shown in FIG. 4 shows that the magnet 120 will drop at the speed on gravity if not imparting a resistance. Use of the Lenz' Law demonstration device 110 is governed by formula

$$ɛ = - \frac{\partial Φ}{\partial t} ,$$

shown by a negative sign in Faraday's Law of Induction. Use of the Lenz' Law demonstration device 100 is used to demonstrate magnetism when compared side by side with the non-conductive tube in FIG. 4. The Lenz' Law demonstration device 100 is able to be ‘side-by-side’ compared with a nonmagnetic drop that the magnet 120 falls at a speed of gravity. In this way potential energy is converted to kinetic energy by use of the magnet 120 passing through the tube 110 with resistance (in the left side diagram in FIG. 4). The electrical charge is able to be externally captured for electric-use if so desired.

In certain embodiments the Lenz' Law demonstration device 100 may further comprise connecting-tubes (not shown); wherein the connecting-tubes are useful for conducting related experiments to demonstrate scientific laws. Those with ordinary skill in the art will now appreciate that upon reading this specification and by their understanding the art of principals of magnetism as described herein, methods of display will be understood by those knowledgeable in such art.

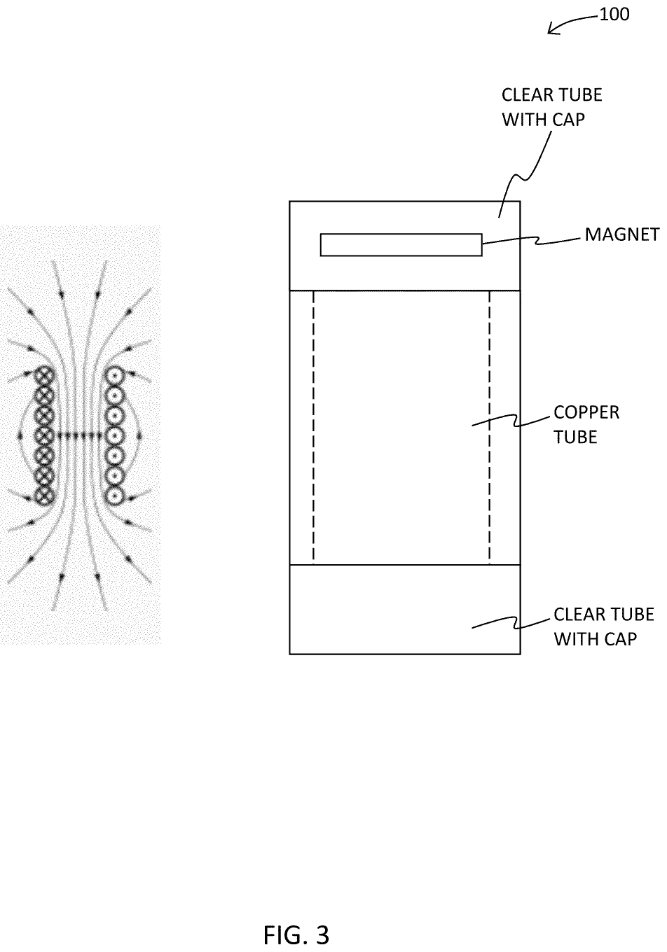

Referring now to FIG. 3, currents bound inside atoms of the magnet 120 is able to create counter-rotating currents in the copper tube 110; wherein the current induced in a circuit due to motion in the magnetic field is so directed as to oppose the change in flux and to exert a mechanical force opposing motion.

In a preferred embodiment of the Lenz' Law demonstration device 100, the demonstration device 100 comprises: a tube 110 having an inner surface 112; an inner volume 114; and an outer surface 116; connecting-tubes; and a magnet 120; wherein the magnet 120 travels within the inner volume 114; the inner surface 112 providing a resistance as the magnet 120 travels and generates an electrical charge via the resistance. In this embodiment the tube 110 comprises copper; wherein the copper tube 110 creates a ‘magnetic drop’ due to the resistance (left side illustration in FIG. 4). The tube 110 has a larger inner-diameter 118 than an outer-diameter 122 of the magnet 120 such that the magnet 120 can pass therethrough. Potential energy is converted to kinetic energy by use of the magnet 120 passing through the tube 110 with the resistance. As such, the use of the Lenz' Law demonstration device 100 is suitable to demonstrate magnetism. In this embodiment the connecting-tubes are useful for conducting related experiments to demonstrate scientific laws. The Lenz' Law demonstration device 100 is configured to demonstrate direction of current induced in a conductor by a changing magnetic field due to induction is such that it creates the magnetic field that opposes the change that produced it.

According to one embodiment, the Lenz' Law demonstration device 100 may be arranged as a kit. The kit may include magnets 120; tubes 110; tubes with connecting tubes; and scientific instructional material. The instructions may detail functional relationships in relation to the structure of the Lenz' Law demonstration device 100 (such that the Lenz' Law demonstration device 100 can be used, maintained, or the like, in a preferred manner).

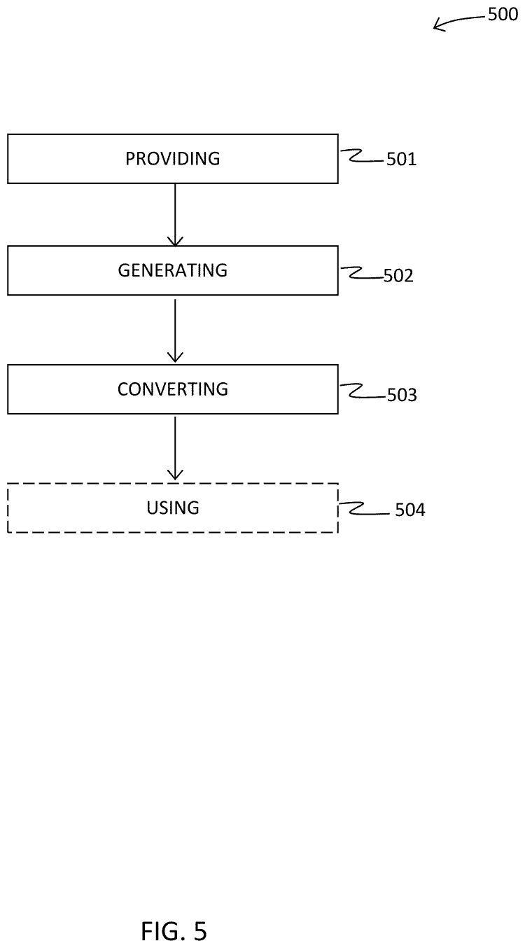

FIG. 5 is a flow diagram illustrating a method of use 500 for the Lenz' Law demonstration device 100, according to an embodiment of the present disclosure. As illustrated, the method of use 500 may include the steps of: 501 providing the Lenz' Law demonstration device; the demonstration device comprising: a tube having an inner surface; an inner volume; and an outer surface; connecting-tubes; and a magnet; 502 generating an electrical charge as the magnet travels within the inner volume; the inner surface providing a resistance; wherein use of the Lenz' Law demonstration device is used to demonstrate magnetism; 503 converting potential energy to kinetic energy by use of the magnet passing through the tube with the resistance such that the Lenz' Law demonstration device is configured to demonstrate direction of current induced in a conductor by a changing magnetic field due to induction is such that it creates the magnetic field that opposes the change that produced it. The method may further comprise the step of: 504 using the connecting-tubes for conducting related experiments to demonstrate scientific laws.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for Lenz' Law demonstration device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A Lenz' Law demonstration device, the demonstration device comprising:
a tube having;
an inner surface;
an inner volume; and
an outer surface; and
a magnet;
wherein said magnet travels within said inner volume, said inner surface providing a resistance as said magnet travels and generates an electrical charge via said resistance; and
wherein such that said Lenz' Law demonstration device is configured to demonstrate direction of current induced in a conductor by a changing magnetic field due to induction is such that it creates the magnetic field that opposes the change that produced it.

2. The Lenz' Law demonstration device of claim 1, wherein said tube comprises copper.

3. The Lenz' Law demonstration device of claim 1, wherein said tube comprises ferromagnetic material.

4. The Lenz' Law demonstration device of claim 2, wherein said magnet due to said resistance is caused to drop at a slower speed in the tube therefore creating an appearance of anti-gravity and generating said electrical charge through the resistance.

5. The Lenz' Law demonstration device of claim 2, wherein changing a diameter of the tube changes in speed can show effects of the magnet and the resistance.

6. The Lenz' Law demonstration device of claim 1, wherein the copper said tube creates a magnetic drop due to said resistance.

7. The Lenz' Law demonstration device of claim 1, wherein use of the Lenz' Law demonstration device is governed by formula
$$ɛ = - \frac{\partial Φ}{\partial t} ,$$
shown by a negative sign in Faraday's law of induction.

8. The Lenz' Law demonstration device of claim 1, wherein use of the Lenz' Law demonstration device is used to demonstrate magnetism.

9. The Lenz' Law demonstration device of claim 1, wherein the electrical charge is able to be externally captured for electric-use.

10. The Lenz' Law demonstration device of claim 1, wherein the Lenz' Law demonstration device is able to be side-by-side compared with a nonmagnetic drop that falls at a speed of gravity.

11. The Lenz' Law demonstration device of claim 1, wherein the Lenz' Law demonstration device further comprises connecting-tubes.

12. The Lenz' Law demonstration device of claim 11, wherein the connecting-tubes are useful for conducting related experiments to demonstrate scientific laws.

13. The Lenz' Law demonstration device of claim 1, wherein potential energy is converted to kinetic energy by use of the magnet passing through the tube with resistance.

14. The Lenz' Law demonstration device of claim 1, wherein the tube has a larger diameter than the magnet.

15. The Lenz' Law demonstration device of claim 2, wherein currents bound inside atoms of said magnet is able to create counter-rotating currents in said copper said tube.

16. The Lenz' Law demonstration device of claim 1, wherein the current induced in a circuit due to motion in said magnetic field is so directed as to oppose the change in flux and to exert a mechanical force opposing motion.

17. A Lenz' Law demonstration device, the demonstration device comprising:
a tube having;
an inner surface;
an inner volume; and
an outer surface;
connecting-tubes; and
a magnet;
wherein said magnet travels within said inner volume, said inner surface providing a resistance as said magnet travels and generates an electrical charge via said resistance;
wherein said tube comprises copper;
wherein the copper said tube creates a magnetic drop due to said resistance;
wherein the tube has a larger inner-diameter than an outer-diameter of the magnet;
wherein use of the Lenz' Law demonstration device is used to demonstrate magnetism;
wherein the connecting-tubes are useful for conducting related experiments to demonstrate scientific laws;
wherein potential energy is converted to kinetic energy by use of the magnet passing through the tube with said resistance; and
wherein such that said Lenz' Law demonstration device is configured to demonstrate direction of current induced in a conductor by a changing magnetic field due to induction is such that it creates the magnetic field that opposes the change that produced it.

18. The Lenz' Law demonstration device of claim 17, further comprising set of instructions; and
wherein the Lenz' Law demonstration device is arranged as a kit.

19. A method of use for the Lenz' Law demonstration device, the method comprising the steps of:
providing said Lenz' Law demonstration device, the demonstration device comprising:
a tube having;
an inner surface;
an inner volume; and
an outer surface;
connecting-tubes; and
a magnet;
generating an electrical charge as said magnet travels within said inner volume, said inner surface providing a resistance;
wherein use of the Lenz' Law demonstration device is used to demonstrate magnetism;
converting potential energy to kinetic energy by use of the magnet passing through the tube with said resistance such that said Lenz' Law demonstration device is configured to demonstrate direction of current induced in a conductor by a changing magnetic field due to induction is such that it creates the magnetic field that opposes the change that produced it.

20. The method of claim 19, further comprising the step of:
using the connecting-tubes for conducting related experiments to demonstrate scientific laws.
